(19) United States
(12) Patent Application Publication
(10) Pub. No.: US 2025/0158111 A1
(43) Pub. Date: May 15, 2025

(54) MULTILAYER CERAMIC ELECTRONIC DEVICE

(71) Applicant: TAIYO YUDEN CO., LTD., Tokyo (JP)

(72) Inventor: Chie KAWAMURA, Tokyo (JP)

(73) Assignee: TAIYO YUDEN CO., LTD., Tokyo (JP)

(21) Appl. No.: 18/727,244

(22) PCT Filed: Jan. 19, 2023
(86) PCT No.: PCT/JP2023/001442

§ 371 Date: Jan. 27, 2025

(30) Foreign Application Priority Data
Feb. 21, 2022 (JP) 2022-024780

(51) Int. Cl. H01M 10/0562; H01G 4/008; H01G 4/012; H01G 4/12; H01G 4/224; H01G 4/30; H01M 10/0585

(52) U.S. Cl. CPC H01M 10/0562; H01G 4/008; H01G 4/012; H01G 4/1209; H01G 4/224; H01M 10/0585; H01G 4/30; H01M 2300/0071

(57) ABSTRACT

A multilayer ceramic electronic device includes a multilayer structure that has a side margin that is provided so as to cover ends of internal electrode layers extending toward two side faces and has a thickness of 10 μm or more and 70 μm or less, wherein with reference to a first straight line drawn from a tip on a side of the side margin in an opposing direction in which the two side faces oppose each other, a distance between the tip and one of a first position where the thickness to a surface on one side in a thickness direction first reaches a maximum value from the tip and a second position where the thickness to a surface on the other side first reaches a maximum value from the tip which is located closer to the tip in the opposing direction is 15 μm or less.

### TECHNICAL FIELD

The present invention relates to a multilayer ceramic electronic device.

### BACKGROUND ART

All solid batteries using oxide-based solid electrolytes are expected to be a technology that can provide safe secondary batteries that do not cause ignition or toxic gas generation, which are concerns with organic electrolytes, sulfide-based solid electrolytes, or the like (For example, see Patent Documents 1 and 2). Such multilayer ceramic electronic devices are expected to have a high capacity due to the structure in which thin ceramic layers and thin internal electrode layers are alternately stacked in a limited device volume.

### PRIOR ART DOCUMENT

### Patent Document

Patent Document 1: Japanese Patent Application Publication No. 2014-116136
Patent Document 2: Japanese Patent Application Publication No. 2021-136112

### DISCLOSURE OF THE INVENTION

### Problems to be Solved by the Invention

Patent Document 1 discloses a shape in which the internal electrode layer is gradually thinned toward the end in order to suppress short circuits. Further, in Patent Document 2, the thickness of the electrode end portion is made thinner than the center. However, if there is a thin part in the electrode portion as in these techniques, it is disadvantageous in terms of capacity.

The present invention has been made in view of the above problems, and an object of the present invention is to provide a small-sized multilayer ceramic electronic device that can realize high capacity.

### Means for Solving the Problem

A multilayer ceramic electronic device of the present invention includes: a multilayer structure that includes a multilayer portion in which a plurality of ceramic layers and a plurality of internal electrode layers are alternately stacked, has a rectangular parallelepiped, the plurality of internal electrode layers being alternately exposed on two end faces of the multilayer structure opposite to each other, the multilayer structure having an upper face, a lower face, and two side faces other than the two end faces, wherein the multilayer structure has a side margin that is provided so as to cover ends of the plurality of internal electrode layers extending toward the two side faces, has a main component of ceramics and has a thickness of 10 μm or more and 70 μm or less, wherein, in at least one of the plurality of internal electrode layers, with reference to a first straight line drawn from a tip on a side of the side margin in an opposing direction in which the two side faces oppose each other, a distance in the opposing direction between the tip and one of a first position where the thickness to a surface on one side in a thickness direction first reaches a maximum value from the tip and a second position where the thickness to a surface on the other side first reaches a maximum value from the tip which is located closer to the tip in the opposing direction is 15 μm or less.

An angle between the first straight line and a second straight line connecting the tip and the one of the first position and the second position closer to the tip in the opposing direction of the above-mentioned multilayer ceramic electronic device may be 15° or more and 90° or less.

In the above-mentioned multilayer ceramic electronic device, the ceramic layer may haves a thickness of 10 μm or more and 30 μm or less.

In the above-mentioned multilayer ceramic electronic device, the plurality of internal electrode layers may have a thickness of 7 μm or more and 60 μm or less.

In the above-mentioned multilayer ceramic electronic device, the plurality of internal electrode layers may be a sintered body.

In the above-mentioned multilayer ceramic electronic device, the plurality of ceramics layers may be oxide-based solid electrolyte layers having ionic conductivity, and the plurality of internal electrode layers may include an electrode active material.

In the above-mentioned multilayer ceramic electronic device, the plurality of ceramics layers may be dielectric layers, and a main component of the plurality of internal electrode layers may be a metal.

### Effects of the Invention

According to the present invention, it is possible to provide a multilayer ceramic electronic device capable of achieving high capacity.

### BRIEF DESCRIPTION OF THE DRAWINGS

FIG. 1 is a schematic cross-sectional view illustrating a basic structure of an all solid battery;

FIG. 2 illustrates a partially cutaway perspective view of a stack type all solid battery in which a plurality of fuel units are stacked;

FIG. 3 illustrates a cross section taken along a line A-A of FIG. 2;

FIG. 4 illustrates a cross section taken along a line B-B of FIG. 2;

FIG. 5 is an enlarged view of an end portion of a first internal electrode layer in a Y-axis direction;

FIG. 6 illustrates a flow of a manufacturing method of an all solid battery;

FIG. 7A to FIG. 7C illustrate a stacking process;

FIG. 8 illustrates a stacking process;

FIG. 9 illustrates a partially cutaway perspective view of a multilayer ceramic capacitor in accordance with a second embodiment;

FIG. 10 illustrates a cross section taken along a line A-A of FIG. 9; and

FIG. 11 illustrates a cross section taken along a line B-B of FIG. 9.

### BEST MODES FOR CARRYING OUT THE INVENTION

A description will be given of an embodiment with reference to the accompanying drawings.

### First Embodiment

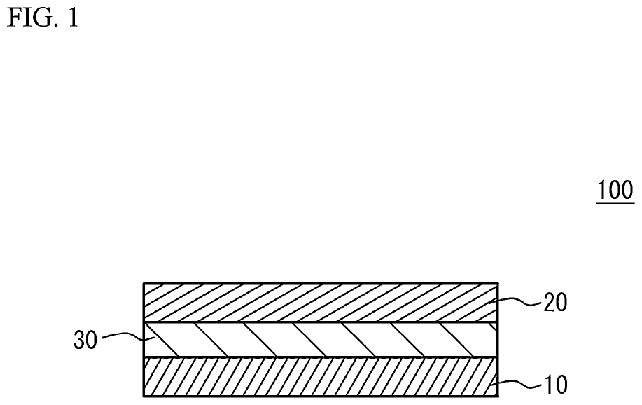

FIG. 1 is a schematic cross-sectional view illustrating the basic structure of an all solid battery 100. As illustrated in FIG. 1, the all solid battery 100 has a structure in which a solid electrolyte layer 30 is sandwiched between a first internal electrode layer 10 and a second internal electrode layer 20. The first internal electrode layer 10 is formed on a first main face of the solid electrolyte layer 30. The second internal electrode layer 20 is formed on a second main face of the solid electrolyte layer 30.

When using the all solid battery 100 as a secondary battery, one of the first internal electrode layer 10 and the second internal electrode layer 20 is used as a positive electrode, and the other is used as a negative electrode. In this embodiment, as an example, the first internal electrode layer 10 is used as a positive electrode layer, and the second internal electrode layer 20 is used as a negative electrode layer.

The solid electrolyte layer 30 has a NASICON type crystal structure and is mainly composed of an oxide-based solid electrolyte having ionic conductivity. The solid electrolyte of the solid electrolyte layer 30 is, for example, an oxide-based solid electrolyte having lithium ion conductivity. The solid electrolyte is, for example, a phosphate solid electrolyte having a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, a Li—Al—Ge—PO₄-based material to which the same transition metal as that contained in the phosphate having an olivine crystal structure contained in the first internal electrode layer 10 and the second internal electrode layer 20 is added in advance is preferable. For example, when the first internal electrode layer 10 and the second internal electrode layer 20 contain a phosphate containing Co and Li, it is preferable that the solid electrolyte layer 30 may contain a Li—Al—Ge—PO₄ material to which Co has been added in advance. In this case, the effect of suppressing elution of the transition metal contained in the electrode active material into the electrolyte can be obtained. When the first internal electrode layer 10 and the second internal electrode layer 20 contain a phosphate containing a transition element other than Co and Li, it is preferable that the Li—Al—Ge—PO₄ material to which the transition metal has been added is added to the solid electrolyte layer 30.

The first internal electrode layer 10 used as the positive electrode includes an electrode active material having an olivine crystal structure. It is preferable that he electrode active material is also contained in the second internal electrode layer 20. The electrode active material is such as phosphates containing transition metals and lithium. The olivine crystal structure is a crystal possessed by natural olivine, and can be determined by X-ray diffraction.

As a typical example of the electrode active material having the olivine crystal structure, LiCoPO₄ containing Co can be used. It is also possible to use a phosphate in which the transition metal Co is replaced in this chemical formula. Here, the ratio of Li and PO₄ may vary depending on the valence. Note that it is preferable to use Co, Mn, Fe, Ni or the like as the transition metal.

The electrode active material having the olivine crystal structure acts as the positive electrode active material in the first internal electrode layer 10 which functions as the positive electrode. For example, if only the first internal electrode layer 10 contains the electrode active material having the olivine crystal structure, the electrode active material acts as the positive electrode active material. When the second internal electrode layer 20 also includes an electrode active material having the olivine type crystal structure, discharge capacity may increase and an operation voltage may increase because of electric discharge, in the second internal electrode layer 20 acting as a negative electrode. The function mechanism is not completely clear. However, the mechanism may be caused by partial solid-phase formation together with the negative electrode active material.

When both the first internal electrode layer 10 and the second internal electrode layer 20 include an electrode active material having the olivine type crystal structure, the electrode active material of each of the first internal electrode layer 10 and the second internal electrode layer 20 may have a common transition metal. Alternatively, the transition metal of the electrode active material of the first internal electrode layer 10 may be different from that of the second internal electrode layer 20. The first internal electrode layer 10 and the second internal electrode layer 20 may have only single type of transition metal. The first internal electrode layer 10 and the second internal electrode layer 20 may have two or more types of transition metal. It is preferable that the first internal electrode layer 10 and the second internal electrode layer 20 have a common transition metal. It is more preferable that the electrode active materials of the both electrode layers have the same chemical composition. When the first internal electrode layer 10 and the second internal electrode layer 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second internal electrode layer 20 includes the negative electrode active material. By containing the negative electrode active material in only one electrode, it becomes clear that the one electrode acts as a negative electrode and the other electrode acts as a positive electrode. However, both electrodes may contain substances known as negative electrode active materials. Regarding the negative electrode active material of the electrode, conventional techniques in secondary batteries can be referred to as appropriate, and for example, compounds such as titanium oxide, lithium titanium composite oxide, lithium titanium composite phosphate, carbon, lithium vanadium phosphate or the like can be used.

In producing the first internal electrode layer 10 and the second internal electrode layer 20, in addition to these electrode active materials, a solid electrolyte having ionic conductivity, a conductive material (conductive auxiliary agent), and the like are added. For these members, a paste for internal electrodes can be obtained by uniformly dispersing a binder and a plasticizer in water or an organic solvent. A carbon material or the like may be included as the conductive auxiliary agent. A metal may be included as the conductive auxiliary agent. Examples of the metal of the conductive auxiliary agent is such as Pd, Ni, Cu, Fe, or alloys containing at least one of these. The solid electrolyte contained in the first internal electrode layer 10 and the second internal electrode layer 20 can be, for example, the same as the solid electrolyte that is the main component of the solid electrolyte layer 30.

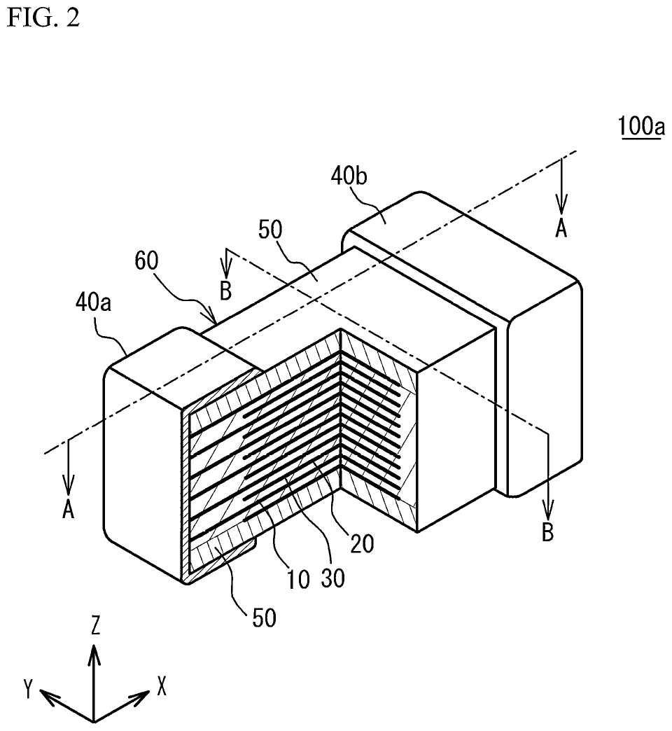

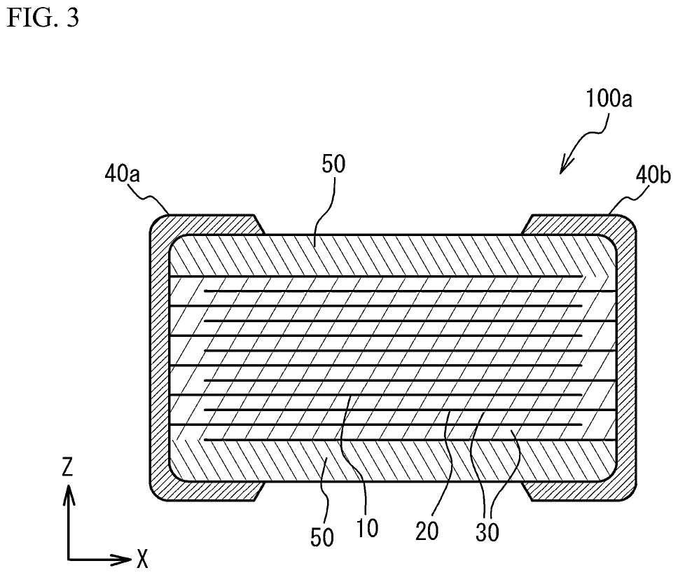

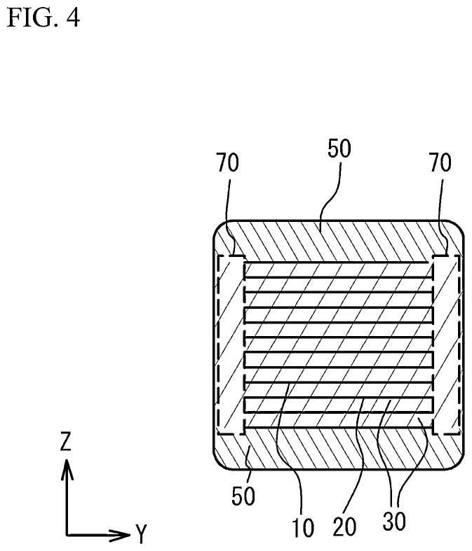

FIG. 2 illustrates a perspective view of a stack type all solid battery 100a in which a plurality of battery units are stacked, in which a cross section of a part of the all solid battery 100a is illustrated. FIG. 3 is a cross-sectional view taken along line A-A in FIG. 2. FIG. 4 is a cross-sectional view taken along line B-B in FIG. 2. The all solid battery 100a includes a multilayer chip 60 having a rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with two side faces (hereinafter referred to as two end faces) facing each other.

In FIG. 2 to FIG. 4, the X-axis direction is a direction in which the two end faces of the multilayer chip 60 are opposite to each other, and is a direction in which the first external electrode 40a and the second external electrode 40b are opposite to each other. The Y-axis direction is the width direction of the first internal electrode layer 10 and the second internal electrode layer 20, and is a direction in which two of the four side faces of the multilayer chip 60 other than the two end faces are opposite to each other. The Z-axis direction is the stacking direction, and is the direction in which the upper face and the lower face of the multilayer chip 60 are opposite to each other. The X-axis direction, the Y-axis direction, and the Z-axis direction are orthogonal to each other.

In the following description, those having the same composition range and the same thickness range as the all solid battery 100 will be given the same reference numerals and detailed description will be omitted.

In the all solid battery 100a, the plurality of first internal electrode layers 10 and the plurality of second internal electrode layers 20 are alternately stacked with the solid electrolyte layers 30 in between. The edges of the plurality of first internal electrode layers 10 in the X-axis direction are exposed to the first end face of the multilayer chip 60 and are not exposed to the second end face. The edges of the plurality of second internal electrode layers 20 in the X-axis direction are exposed to the second end face of the multilayer chip 60 and are not exposed to the first end face. Thereby, the first internal electrode layer 10 and the second internal electrode layer 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper face of the multilayer structure of the first internal electrode layer 10, the solid electrolyte layer 30, and the second internal electrode layer 20. The cover layer 50 is in contact with the uppermost internal electrode layer (either one of the first internal electrode layer 10 and the second internal electrode layer 20) and is in contact with a part of the solid electrolyte layer 30. Another cover layer 50 is also stacked on the lower face of the multilayer structure. The cover layer 50 is in contact with the lowermost internal electrode layer (either one of the first internal electrode layer 10 and the second internal electrode layer 20) and is in contact with a part of the solid electrolyte layer 30.

As illustrated in FIG. 3, a section where the first internal electrode layer 10 connected to the first external electrode 40a and the second internal electrode layer 20 connected to the second external electrode 40b face each other produces battery capacity.

As illustrated in FIG. 4, in the multilayer chip 60, a section from the two side faces of the multilayer chip 60 to the first internal electrode layer 10 and the second internal electrode layer 20 is referred to as a side margin 70. That is, the side margin 70 is a section provided so as to cover the ends of the plurality of first internal electrode layers 10 and second internal electrode layers 20 stacked in the above-described multilayer structure extending toward the two side faces. The side margin 70 may have the same composition as the solid electrolyte layer 30 in the section where the first internal electrode layer 10 and the second internal electrode layer 20 face each other, or may have a different composition.

For example, short circuits may be suppressed by making the ends of the first internal electrode layer 10 and the second internal electrode layer 20 thinner in the Y-axis direction. However, the stack type all solid battery 100a is required to have a higher capacity with a limited component volume. If a thin part exists in the electrode portion, it will be disadvantageous in terms of battery capacity. Next, it is conceivable to make the side margin 70 thicker in order to suppress short circuits. However, if the side margin 70 is made thicker, the all solid battery 100a will become larger. Therefore, the all solid battery 100a according to this embodiment is small and has a configuration that can realize high capacity.

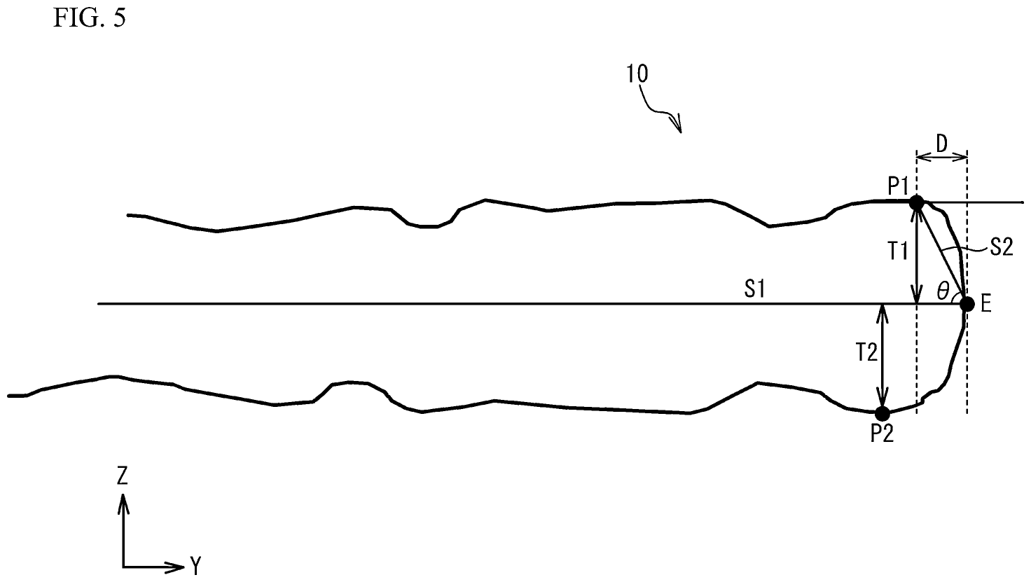

FIG. 5 is an enlarged view of the end portion of the first internal electrode layer 10 in the Y-axis direction. As illustrated in FIG. 5, the tip of the first internal electrode layer 10 in the Y-axis direction is referred to as a tip E. The tip E may appear at the center in the Z-axis direction (thickness direction) of the first internal electrode layer 10, or may appear at a position shifted from the center in the Z-axis direction. A straight line drawn from the tip E in the Y-axis direction is defined as a straight line S1 (first straight line). The thickness of the first internal electrode layer 10 up to the upper surface of the multilayer chip 60 at each position in the Y-axis direction with respect to the straight line S1 is defined as a thickness T1. The thickness of the first internal electrode layer 10 up to the lower surface of the multilayer chip 60 at each position in the X-axis direction with respect to the straight line S1 is defined as a thickness T2.

As the distance from the tip E increases in the X-axis direction, the thickness T1 gradually increases and reaches a maximum value M1. As the distance from the tip E increases in the X-axis direction, the thickness T2 also gradually increases and reaches a maximum value M2. Among the position P1 (first position) where the thickness T1 first becomes the local maximum value M1 when moving from the tip E in the X-axis direction, and the position P2 (second position) where the thickness T2 first takes the local maximum value M2, the distance in the Y-axis direction between the tip closest to the tip E and the tip E in the Y-axis direction is defined as a distance D. Further, the angle between the straight line S2 (second straight line) connecting one of the position P1 and the position P2 that is closer to the tip E in the Y-axis direction and the tip E is defined as the angle θ. The second internal electrode layer 20 is also given the same name as the first internal electrode layer 10.

Note that the cross-sectional shapes of the ends of the first internal electrode layer 10 and the second internal electrode layer 20 in the Y-axis direction can be observed by obtaining an SEM photograph of the cross-section of the YZ plane at the center of the multilayer chip 60 in the X-axis direction.

When the distance D is long, the thinner portion of the first internal electrode layer 10 and the second internal electrode layer 20 at the tips in the Y-axis direction becomes long. In this case, there is a risk that the battery capacity will decrease. When the distance D is short, the portion where the first internal electrode layer 10 and the second internal electrode layer 20 become thinner at the tips in the Y-axis direction becomes shorter. Thereby, battery capacity can be improved. Therefore, in this embodiment, an upper limit is set for the distance D. Specifically, the distance D is set to 15 μm or less.

Next, if the side margin 70 is thin in the Y-axis direction, it becomes susceptible to external shocks and moisture contained in the outside air, and the first internal electrode layer 10 and the second internal electrode layer 20 are not sufficiently protected, and there is a possibility that the first internal electrode layer 10 and the second internal electrode layer 20 may be short-circuited. Therefore, in this embodiment, a lower limit is set for the thickness of the side margin 70 in the Y-axis direction. Specifically, the thickness of the side margin 70 in the Y-axis direction is 10 μm or more. Thereby, short circuits are suppressed, and a decrease in yield is suppressed.

On the other hand, if the side margin 70 is thick in the Y-axis direction, the volume ratio of the side margin 70 that does not contribute to the battery capacity increases, and the battery capacity of the all solid battery 100a decreases. If an attempt is made to increase the volume of the portion that contributes to battery capacity, the all solid battery 100a will become larger. Therefore, in this embodiment, an upper limit is set for the thickness of the side margin 70 in the Y-axis direction. Specifically, the thickness of the side margin 70 in the Y-axis direction is set to 70 μm or less. Thereby, it is possible to suppress an increase in the size of the all solid battery 100a.

As described above, by setting the thickness of the side margin 70 in the Y-axis direction to 10 μm or more and 70 μm or less, and setting the distance D to 15 μm or less, it is possible to achieve high capacity while suppressing the increase in size of the all solid battery 100a.

Note that if the first internal electrode layer 10 and the second internal electrode layer 20 have the same thickness up to the tips in the Y-axis direction, the first internal electrode layer 10 and the second internal electrode layer 20 do not have locally thin portions, and it is assumed that high capacity can be achieved. However, in the stack type all solid battery 100a, since the first internal electrode layer 10 and the second internal electrode layer 20 are sintered bodies formed by sintering powder materials, the tips in the Y-axis direction becomes deformed. For this reason, the present inventor realized a small, high-capacity all solid battery 100a by controlling the shapes of the tips of the first internal electrode layer 10 and the second internal electrode layer 20 in the Y-axis direction.

In at least one of the first internal electrode layer 10 and the second internal electrode layer 20, it is sufficient that the thickness of the side margin 70 in the Y-axis direction is 10 μm or more and 70 μm or less at one end in the Y-axis direction, and the distance D is 15 μm or less. In a multilayer structure in which a plurality of internal electrode layers are stacked, the ratio of the number of stacked internal electrode layers with a distance D of 15 μm or less at either end in the Y-axis direction is preferably 60% or more, more preferably 70% or more and, still more preferably 80% or more.

From the viewpoint of obtaining sufficient battery capacity, the distance D is preferably 15 μm or less, more preferably 10 μm or less.

From the viewpoint of shortening the distance D, it is preferable to set a lower limit to the angle θ. Specifically, the angle θ is preferably 15° or more, more preferably 17° or more, and even more preferably 20° or more.

The distance D is preferably 0 μm or more, more preferably 1 μm or more, and even more preferably 5 μm or more.

Further, the angle θ is preferably 90° or less, more preferably 80° or less, and even more preferably 70° or less.

From the viewpoint of suppressing short circuit between the first internal electrode layer 10 and the second internal electrode layer 20, the thickness of the side margin 70 in the Y-axis direction is preferably 10 μm or more, and more preferably 15 μm or more.

From the viewpoint of suppressing the increase in size of the all solid battery 100a, the thickness of the side margin 70 in the Y-axis direction is preferably 70 μm or less, more preferably 60 μm or less.

Next, if the solid electrolyte layer 30 is thin, there is a risk of a short circuit due to contact between the first internal electrode layer 10 and the second internal electrode layer 20. Therefore, it is preferable to set a lower limit on the thickness of the solid electrolyte layer. Specifically, the thickness of the solid electrolyte layer 30 is preferably 10 μm or more, more preferably 12 μm or more, and even more preferably 15 μm or more.

On the other hand, if the solid electrolyte layer 30 is thick, there is a risk of a decrease in capacity and response. Therefore, it is preferable to set an upper limit on the thickness of the solid electrolyte layer 30. Specifically, the thickness of the solid electrolyte layer 30 is preferably 30 μm or less, more preferably 25 μm or less, and even more preferably 20 μm or less.

Next, if the first internal electrode layer 10 and the second internal electrode layer 20 are thin, there is a risk that sufficient battery capacity may not be necessarily obtained. Therefore, it is preferable to set a lower limit on the thickness of the first internal electrode layer 10 and the second internal electrode layer 20. Specifically, the thickness of the first internal electrode layer 10 and the second internal electrode layer 20 is preferably 7 μm or more, more preferably 10 μm or more, and even more preferably 12 μm or more.

On the other hand, if the first internal electrode layer 10 and the second internal electrode layer 20 are thick, there is a risk that the responsiveness will decrease. Therefore, it is preferable to set an upper limit on the thickness of the first internal electrode layer 10 and the second internal electrode layer 20. Specifically, the thickness of the first internal electrode layer 10 and the second internal electrode layer 20 is preferably 60 μm or less, more preferably 55 μm or less, and even more preferably 50 μm or less.

For each thickness of the first internal electrode layer 10, the second internal electrode layer 20, the solid electrolyte layer 30, and the side margin 70, for example, 10 layers are selected at random, and the average thickness of 10 different points of each layer is calculated.

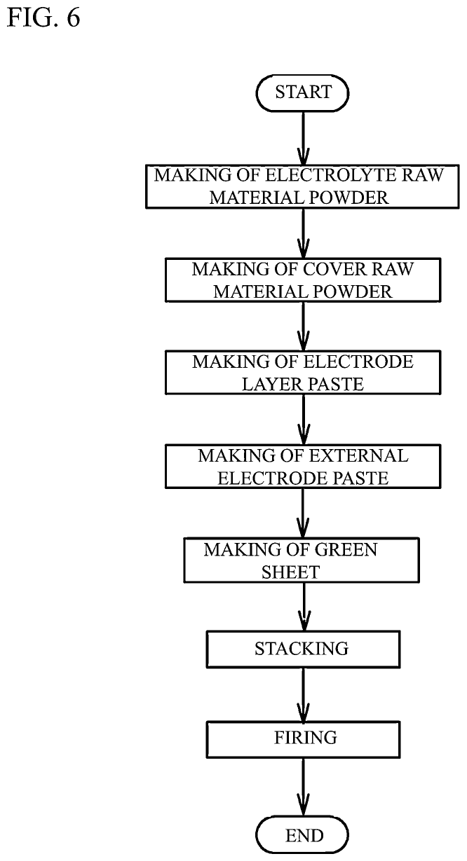

Next, a method for manufacturing the all solid battery 100a illustrated in FIG. 2 will be described. FIG. 6 is a flowchart of the method for manufacturing the all solid battery 100a.

(Making process of raw material powder for solid electrolyte layer) First, a raw material powder for a solid electrolyte layer constituting the solid electrolyte layer 30 described above is produced. For example, the raw material powder for an oxide-based solid electrolyte can be produced by mixing raw materials, additives, and so on and using a solid phase synthesis method. By dry-pulverizing the obtained raw material powder, it is possible to adjust the raw material powder to a desired average particle size. For example, the particles are adjusted to a desired average particle size using a planetary ball mill using ZrO₂ balls of 5 mm diameter.

(Making process of raw material powder for cover layer) First, a raw material powder of ceramics constituting the above-mentioned cover layer 50 is produced. For example, the raw material powder for the cover layer can be produced by mixing raw materials, additives, and so on and using a solid phase synthesis method. By dry-pulverizing the obtained raw material powder, it is possible to adjust the raw material powder to a desired average particle size. For example, the particles are adjusted to a desired average particle size using a planetary ball mill using ZrO₂ balls of 5 mm diameter.

(Making process of paste for internal electrode layer) Next, an internal electrode paste for producing the above-described first internal electrode layer 10 and the second internal electrode layer 20 are separately produced. For example, the internal electrode paste can be obtained by uniformly dispersing a conductive auxiliary agent, an electrode active material, a solid electrolyte material, a sintering aid, a binder, a plasticizer and so on in water or an organic solvent. The solid electrolyte paste described above may be used as the solid electrolyte material. A carbon material or the like is used as a conductive auxiliary agent. A metal may be used as the conductive auxiliary agent. Examples of the metal of the conductive auxiliary agent include Pd, Ni, Cu, Fe, or alloys containing these. Pd, Ni, Cu, Fe, alloys containing these, various carbon materials or the like may also be used.

As the sintering aid for the paste for internal electrode layer, for example, any one of glass component such as Li—B—O based compounds, Li—Si—O based compounds, Li—C—O based compounds, Li—S—O based compounds, and Li—P—O based compounds can be used.

(Making process for paste for external electrode) Next, a paste for external electrode for the first external electrode 40a and the second external electrode 40b described above is prepared. For example, the paste for external electrode can be obtained by uniformly dispersing a conductive material, glass frit, binder, plasticizer and so on in water or an organic solvent.

(Making process of solid electrolyte green sheet) By uniformly dispersing the raw material powder for solid electrolyte layer in an aqueous or organic solvent together with a binder, dispersant, plasticizer and so on and performing wet pulverization, a solid electrolyte slurry having a desired average particle size can be created. At this time, a bead mill, a wet jet mill, various kneaders, a high-pressure homogenizer or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be produced by applying the obtained solid electrolyte paste. The applying method is not particularly limited, and a slot die method, reverse coating method, gravure coating method, bar coating method, doctor blade method or the like can be used. The particle size distribution after wet pulverization can be measured using, for example, a laser diffraction measuring device using a laser diffraction scattering method.

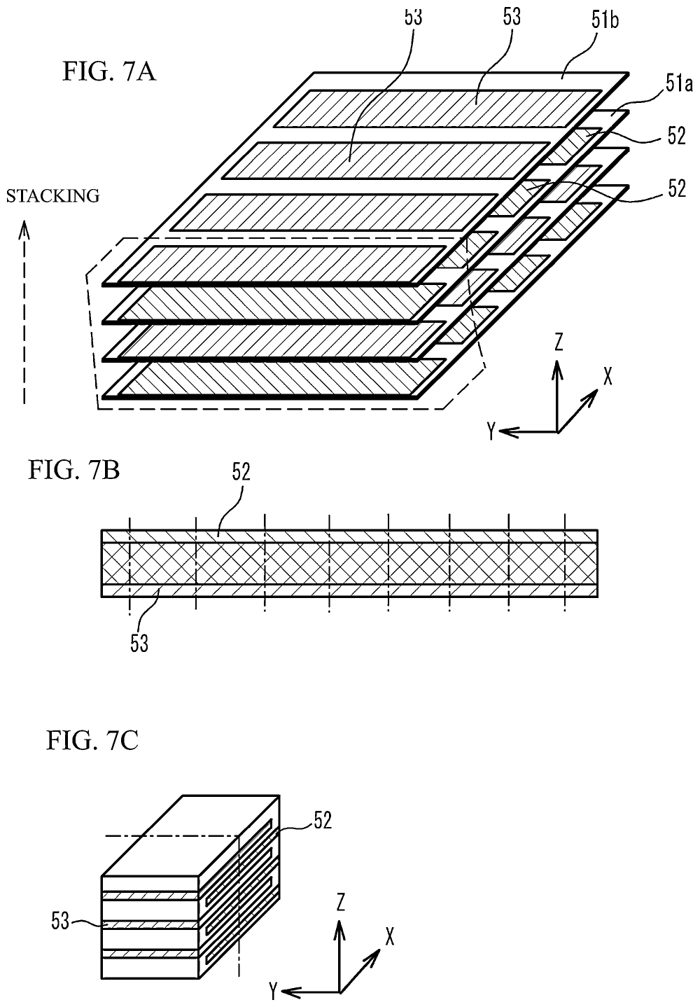

(Stacking Process) As illustrated in FIG. 7A, by printing an internal electrode paste for forming the first internal electrode layer 10 on one face of a first solid electrolyte green sheet 51a at predetermined intervals, a plurality of first internal electrode patterns 52 are formed. Further, by printing an internal electrode paste for forming the second internal electrode layer 20 at predetermined intervals on one face of the second solid electrolyte green sheet 51b, a plurality of second internal electrode patterns 53 are formed. The first solid electrolyte green sheets 51a and the second solid electrolyte green sheets 51b are alternately stacked. In this case, the first internal electrode patterns 52 and the second internal electrode patterns 53 are alternately shifted in the X-axis direction and stacked.

After a cover sheet 54 is pressed from above and below in the stacking direction of the multilayer structure, the multilayer structure is cut into individual pieces as illustrated in FIG. 7B. As a result, the first internal electrode pattern 52 and the second internal electrode pattern 53 are exposed at the ends in the Y-axis direction, as illustrated in FIG. 7C. The first internal electrode pattern 52 is exposed on one of the two end faces in the X-axis direction, and the second internal electrode pattern 53 is exposed on the other.

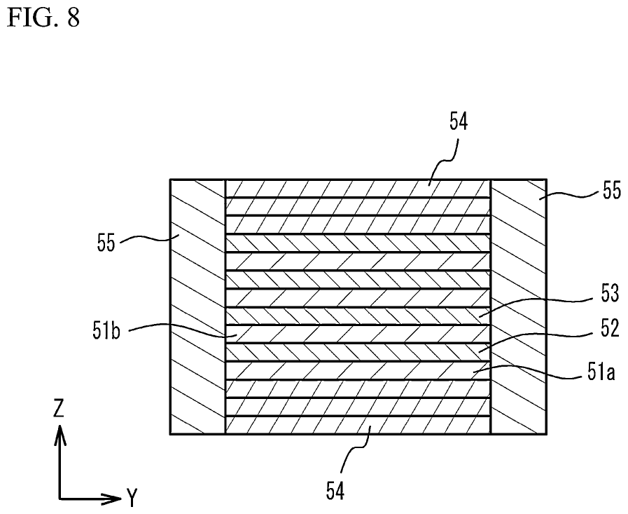

Next, as illustrated in FIG. 8, a side margin sheet 55 is attached to both ends in the Y-axis direction. The side margin sheet 55 contains, for example, the same components as the first solid electrolyte green sheet 51a and the second solid electrolyte green sheet 51b.

Next, an external electrode paste is applied to each of the two end faces by a dipping method or the like and dried. Thereby, a compact for forming the all solid battery 100a is obtained.

(Firing process) Next, the obtained compact is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce the process costs, it is desirable to fire at as low a temperature as possible. After firing, re-oxidation process may be performed. Through the above steps, the all solid battery 100a is produced.

In the above manufacturing method, the edges are formed by cutting as illustrated in FIG. 7C, and the electrode layer can be selectively polished by selecting a material with appropriate hardness for the abrasive and sufficiently finer than the thickness of the electrode layer for the barrel processing. By applying a side margin sheet after that, the edges of the first internal electrode layer 10 and the second internal electrode layer 20 in the Y-axis direction can be shaped as illustrated in FIG. 5. Thereby, the distance D can be set to 10 μm or less. By adjusting the thickness of the side margin sheet 55, the thickness of the side margin 70 after firing can be adjusted to 10 μm or more and 70 μm or less.

### Second Embodiment

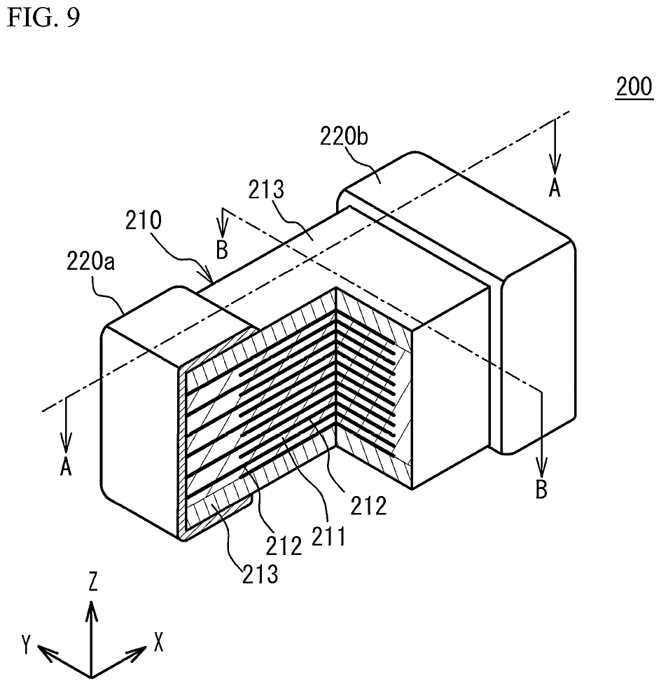

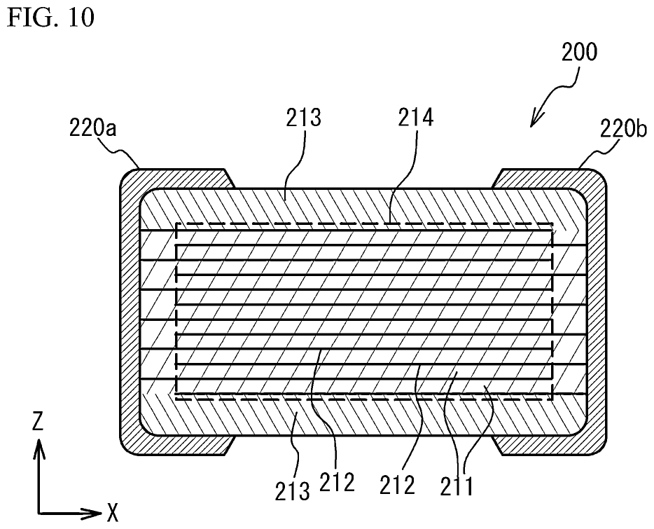

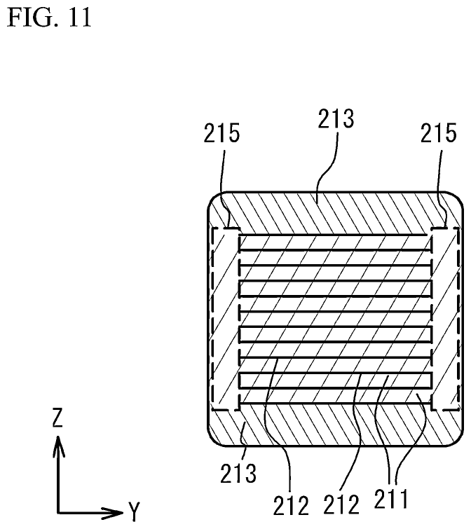

FIG. 9 illustrates a perspective view of a multilayer ceramic capacitor 200 in accordance with a second embodiment, in which a cross section of a part of the multilayer ceramic capacitor 200 is illustrated. FIG. 10 is a cross-sectional view taken along line A-A in FIG. 9. FIG. 11 is a cross-sectional view taken along line B-B in FIG. 9. As illustrated in FIG. 9 to FIG. 11, the multilayer ceramic capacitor 200 includes a multilayer chip 210 having a rectangular parallelepiped shape, and external electrodes 220a and 220b that are respectively provided on two end faces of the multilayer chip 210 facing each other. Among four faces other than the two end faces of the multilayer chip 210, two faces other than the upper face and the lower face in the stacking direction are referred to as side faces. Each of the external electrodes 220a and 220b extends to the upper face and the lower face in the stacking direction and the two side faces of the multilayer chip 210. However, the external electrodes 220a and 220b are spaced from each other.

In FIG. 9 to FIG. 11, an X-axis direction is a longitudinal direction of the multilayer chip 210. The X-axis direction is a direction in which the two end faces of the multilayer chip 210 are opposite to each other and in which the external electrode 220a is opposite to the external electrode 220b. A Y-axis direction is a width direction of the internal electrode layers 212. The Y-axis direction is a direction in which the two side faces other than the two end faces among the four side faces of the multilayer chip 210 are opposite to each other. A Z-axis direction is the stacking direction. The Z-axis direction is a direction in which the upper face and the lower face of the multilayer chip 210 are opposite to each other. The X-axis direction, the Y-axis direction and the Z-axis direction are orthogonal to each other.

The multilayer chip 210 has a configuration in which dielectric layers 211 containing a ceramic material that functions as a dielectric and internal electrode layers 212 mainly composed of metal are alternately stacked. In other words, the multilayer chip 210 includes the plurality of mutually opposing internal electrode layers 212 and dielectric layers 211 sandwiched between the plurality of internal electrode layers 212. End edges of the internal electrode layers 212 are alternately exposed to an end face of the multilayer chip 210 and another end face of the multilayer chip 210. Thus, the internal electrode layers 212 are alternately electrically connected to the external electrode 220a and the external electrode 220b. Accordingly, the multilayer ceramic capacitor 200 has a structure in which the plurality of dielectric layers 211 are stacked with the internal electrode layers 212 interposed therebetween. In the multilayer structure of the dielectric layers 211 and the internal electrode layers 212, the outermost layers in the stack direction are the internal electrode layers 212, and cover layers 213 cover the top face and the bottom face of the multilayer structure. The cover layer 213 is mainly composed of a ceramic material. For example, the main component of the cover layer 213 may be the same as the main component of the dielectric layer 211 or may be different from the main component of the dielectric layer 211.

A main component of the dielectric layer 211 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr₂O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like.

Additives may be added to the dielectric layer 211. As additives to the dielectric layer 211, magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

The main component of the internal electrode layer 212 is a base metal such as Ni (nickel), Cu (copper), Sn (tin). As a main component of the internal electrode layers 212, noble metals such as Pt (platinum), Pd (palladium), Ag (silver), Au (gold), and alloys containing these may be used.

As illustrated in FIG. 10, the section where the internal electrode layers 212 connected to the external electrode 220a faces the internal electrode layers 212 connected to the external electrode 220b is a section where capacity is generated in the multilayer ceramic capacitor 200. Thus, this section is referred to as a capacity section 214. That is, the capacity section 214 is a section where two adjacent internal electrode layers 212 connected to different external electrodes face each other.

As illustrated in FIG. 11, in the multilayer chip 210, the section extending from the two side faces of the multilayer chip 210 to the internal electrode layer 212 is referred to as a side margin 215. That is, the side margin 215 is a section provided to cover the ends of the plurality of internal electrode layers 212 stacked in the above-mentioned multilayer structure that extend to the two side faces. The side margin 215 is a section that does not generate electrostatic capacity. The side margin 215 may have the same composition as the dielectric layer 211 in the capacity section 214, or it may have a different composition.

Even in the multilayer ceramic capacitor 200, if the internal electrode layer 212 is thinner at the ends in the Y-axis direction, this is disadvantageous in terms of electrostatic capacity. Therefore, in the multilayer ceramic capacitor 200, the end portions of the internal electrode layers 212 in the Y-axis direction have the same shape as the first internal electrode layer 10 and the second internal electrode layer 20 of the all solid battery 100a according to the first embodiment.

For example, in this embodiment as well, the distance D for the internal electrode layer 212 is set to 15 μm or less. Further, the thickness of the side margin 215 in the Y-axis direction is set to 10 μm or more and 70 μm or less. Thereby, it is possible to suppress the increase in the size of the multilayer ceramic capacitor 200 and realize a high capacity.

### Examples

### Examples 1 to 5 and Comparative Examples 1 and 2

A stack type all solid battery was manufactured according to the manufacturing method according to the above embodiment. On the first solid electrolyte green sheet, the internal electrode paste for the first internal electrode layer (positive electrode layer) was applied and formed by screen printing to form the first internal electrode pattern. On the second solid electrolyte green sheet, the internal electrode paste for the second internal electrode layer (negative electrode layer) was applied and formed by screen printing to form the second internal electrode pattern. The internal electrode paste for the positive electrode layer and the internal electrode paste for the negative electrode layer were made to have the same thickness. The plurality of first solid electrolyte green sheets and the plurality of second solid electrolyte green sheets were stacked so that the positive electrode layer and the negative electrode layer were alternately pulled out to the left and right. The total number of stacked layers of the first solid electrolyte green sheet and the second solid electrolyte green sheet was 10 layers. It was cut to a predetermined size and a side margin sheet was attached to obtain a green chip for the stacked all solid battery. The green chip was sintered by degreasing and firing, and external electrodes were formed by applying and curing the external electrode paste to obtain the stack type all solid battery.

In Example 1, the thickness of the side margin in the Y-axis direction was 10 μm. The thickness of the first internal electrode layer and the second internal electrode layer was 15 μm. The thickness of the solid electrolyte layer was 15 μm. The distance D was 15 μm. The angle θ was 16°.

In Example 2, the thickness of the side margin in the Y-axis direction was 70 μm. The thickness of the first internal electrode layer and the second internal electrode layer was 15 μm. The thickness of the solid electrolyte layer was 15 μm. The distance D was 10 μm. The angle θ was 45°.

In Example 3, the thickness of the side margin in the Y-axis direction was 10 μm. The thickness of the first internal electrode layer and the second internal electrode layer was 30 μm. The thickness of the solid electrolyte layer was 15 μm. The distance D was 10 μm. The angle θ was 20°.

In Example 4, the thickness of the side margin in the Y-axis direction was 10 μm. The thickness of the first internal electrode layer and the second internal electrode layer was 10 μm. The thickness of the solid electrolyte layer was 15 μm. The distance D was 10 μm. The angle θ was 51°.

In Example 5, the thickness of the side margin in the Y-axis direction was 10 μm. The thickness of the first internal electrode layer and the second internal electrode layer was 15 μm. The thickness of the solid electrolyte layer was 10 μm. The distance D was 10 μm. The angle θ was 30°.

In Comparative Example 1, the thickness of the side margin in the Y-axis direction was 100 μm. The thickness of the first internal electrode layer and the second internal electrode layer was 15 μm. The thickness of the solid electrolyte layer was 15 μm. The distance D was 20 μm. The angle θ was 10°.

In Comparative Example 2, the thickness of the side margin in the Y-axis direction was 8 μm. The thickness of the first internal electrode layer and the second internal electrode layer was 15 μm. The thickness of the solid electrolyte layer was 15 μm. The distance D was 10 μm. The angle θ was 40°.

(Analysis) For each of Examples 1 to 5 and Comparative Examples 1 and 2, CC charge/discharge measurement was performed at 25° C. (charging current: 0.2 C, discharge current: 0.2 C, cut voltage upper limit: 3.6V, lower limit: 1.5V). The ratio of the discharge capacity value of each battery when the discharge capacity of Example 2 was taken as 100% was calculated as the capacity value. Further, for each of Examples 1 to 5 and Comparative Examples 1 and 2, the short rate (ratio of the number of samples in which short circuits occurred) of 200 samples was measured. In addition, the side margin volume ratio was calculated for each of Examples 1 to 5 and Comparative Examples 1 and 2.

Regarding the battery capacity value, if it was 80% or more, it was judged to pass, and if it was less than 80%, it was judged to be failed. Regarding the short rate, if it was 20% or less, it was judged to pass, and if it exceeded 20%, it was judged to be failed. Regarding the side margin volume ratio, if it was 2% or less, it was judged to pass, and if it exceeded 2%, it was judged to be failed. If all of the battery capacity value, the short-circuit rate, and the side margin volume ratio passed, it was judged to be “∘”, and if any one of them failed, it was judged to be “x”.

All of Examples 1 to 5 were judged as “o”. This is thought to be because by setting the thickness of the side margin to 10 μm or more and 70 μm or less and the distance D to 10 μm or less, it was possible to achieve high capacity while suppressing the increase in size of the all solid battery. In Comparative Example 1, the side margin volume ratio was judged to be failed. This is because the side margins are formed thick. In Comparative Example 2, the short rate was judged to be failed. This is considered to be because the internal electrode layers were not sufficiently protected because the side margins were formed thin. In Comparative Example 2, the short circuit rate was high, so the battery capacity value could not be measured.

TABLE 1

| | | | | | SOLID | | | SIDE | |
|---|---|---|---|---|---|---|---|---|---|
| | SIDE | | | INTERNAL | ELECTROLYTE | | | MARGIN | |
| | MARGIN | DISTANCE | ANGLE | ELECTRODE | LAYER | | SHORT | VOLUME | |
| | THICKNESS | D | θ | THICKNESS | THICKNESS | | RATE | RATIO | |
| | (μm) | (μm) | (°) | (μm) | (μm) | CAPACITY | (%) | (%) | JUDGE |
| EXAMPLE 1 | 10 | 10 | 16 | 15 | 15 | 104% | 4 | 0.2 | ∘ |
| EXAMPLE 2 | 70 | 10 | 45 | 15 | 15 | 100% | 3 | 1.6 | ∘ |
| EXAMPLE 3 | 10 | 10 | 20 | 30 | 15 | 138% | 5 | 0.2 | ∘ |
| EXAMPLE 4 | 10 | 10 | 51 | 10 | 15 | 83% | 5 | 0.2 | ∘ |
| EXAMPLE 5 | 10 | 10 | 30 | 15 | 10 | 103% | 20 | 0.2 | ∘ |
| COMPARATIVE | 100 | 20 | 10 | 15 | 15 | 97% | 4 | 2.2 | x |
| EXAMPLE 1 | | | | | | | | | |
| COMPARATIVE | 8 | 10 | 40 | 15 | 15 | — | 55 | 0.2 | x |
| EXAMPLE 2 | | | | | | | | | |

Although the embodiments of the present invention have been described in detail, it is to be understood that the various change, substitutions, and alterations could be made hereto without departing from the spirit and scope of the invention.

1. A multilayer ceramic electronic device comprising:
a multilayer structure that includes a multilayer portion in which a plurality of ceramic layers and a plurality of internal electrode layers are alternately stacked, has a rectangular parallelepiped, the plurality of internal electrode layers being alternately exposed on two end faces of the multilayer structure opposite to each other, the multilayer structure having an upper face, a lower face, and two side faces other than the two end faces,
wherein the multilayer structure has a side margin that is provided so as to cover ends of the plurality of internal electrode layers extending toward the two side faces, has a main component of ceramics and has a thickness of 10 μm or more and 70 μm or less, and
wherein, in at least one of the plurality of internal electrode layers, with reference to a first straight line drawn from a tip on a side of the side margin in an opposing direction in which the two side faces oppose each other, a distance in the opposing direction between the tip and one of a first position where the thickness to a surface on one side in a thickness direction first reaches a maximum value from the tip and a second position where the thickness to a surface on the other side first reaches a maximum value from the tip which is located closer to the tip in the opposing direction is 15 μm or less.

2. The multilayer ceramic electronic device as claimed in claim 1, wherein an angle between the first straight line and a second straight line connecting the tip and the one of the first position and the second position closer to the tip in the opposing direction is 15° or more and less than 90°.

3. The multilayer ceramics electronic device as claimed in claim 1, wherein the ceramic layer has a thickness of 10 μm or more and 30 μm or less.

4. The multilayer ceramic electronic device as claimed in claim 1, wherein the plurality of internal electrode layers have a thickness of 7 μm or more and 60 μm or less.

5. The multilayer ceramic electronic device as claimed in claim 1, wherein the plurality of internal electrode layers is a sintered body.

6. The multilayer ceramic electronic device as claimed in claim 1,
wherein the plurality of ceramics layers are oxide-based solid electrolyte layers having ionic conductivity, and
wherein the plurality of internal electrode layers include an electrode active material.

7. The multilayer ceramic electronic device as claimed in claim 1,
wherein the plurality of ceramics layers are dielectric layers, and
wherein a main component of the plurality of internal electrode layers is a metal.

8. The multilayer ceramic electronic device as claimed in claim 1, wherein in at least 60% of the plurality of internal electrode layers, the distance between the tip and the one closer to the tip in the opposing direction is 15 μm or less.
